(19) United States
(12) Patent Application Publication
(10) Pub. No.: US 2009/0309834 A1
(43) Pub. Date: Dec. 17, 2009

(54) Laser Pointer Mouse

(75) Inventor: Brian Adams, Greensburg, PA (US)

Correspondence Address: UPMC, U.S. STEEL TOWER, SUITE 6082, 600 GRANT STREET, PITTSBURGH, PA, 15219, US

(73) Assignee: UPMC, Pittsburgh, PA (US)

(21) Appl. No.: 12/483,475

(22) Filed: Jun. 12, 2009

Related U.S. Application Data
(60) Provisional application No. 61/061,691, filed on Jun. 16, 2008.

(51) Int. Cl. G09G 5/08

(52) U.S. Cl. 345/166

(57) ABSTRACT

An apparatus includes a monitor, a camera for sensing an image on the monitor, a translucent material positioned between the monitor and the camera, and a processor for receiving the sensed image from the camera, determining a location of a laser spot with respect to the sensed image, and controlling an aspect of the display in response to the location of the spot. A method performed by the apparatus is also provided.

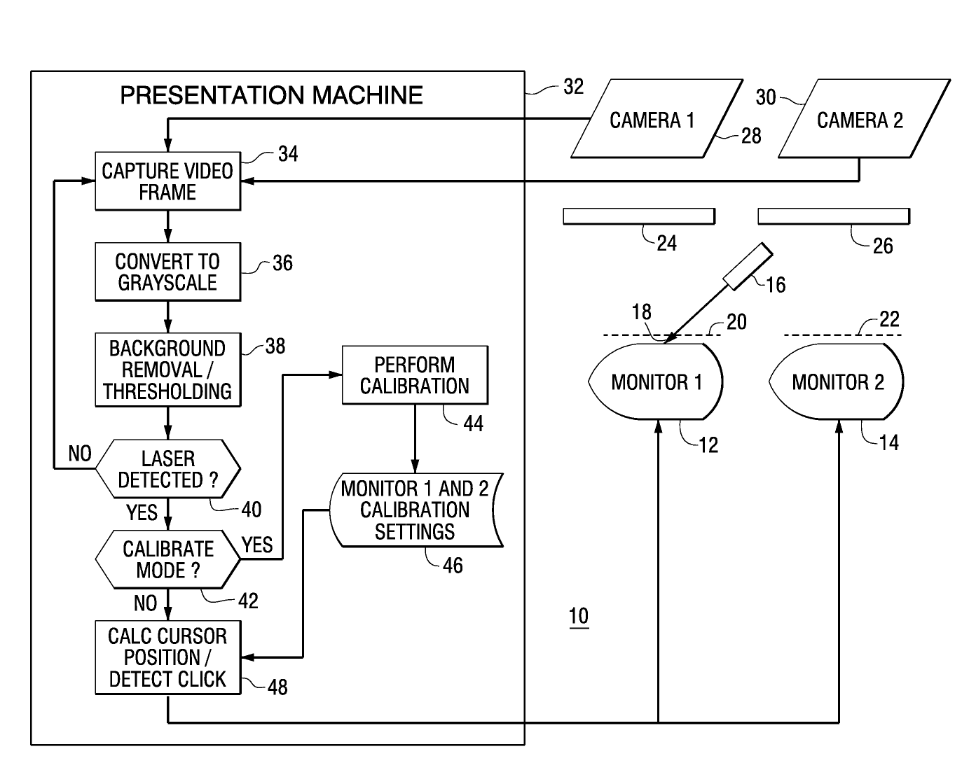

### CROSS-REFERENCE TO RELATED APPLICATION

This application claims the benefit of U.S. Provisional Patent Application Ser. No. 61/061,691, filed Jun. 16, 2008, which is hereby incorporated by reference.

### FIELD OF THE INVENTION

This invention relates generally to methods and apparatus for remotely controlling computer systems, and more particularly to such methods and apparatus for controlling a computer system by means of a wireless optical device.

### BACKGROUND OF THE INVENTION

Information systems are being developed for use at the point of care by care team members, patients, and others in hospitals or other health care facilities. Such systems can link relevant information and the patient, and selectively supply portions of the available patient information to members of a health care team, the patient, and others. In one example of an information system, a computer is connected to multiple monitors that can be mounted in a patient room.

### SUMMARY OF THE INVENTION

In a first aspect, the invention provides an apparatus including: a monitor; a camera for sensing an image on the monitor; a translucent material positioned between the monitor and the camera; and a processor for receiving the sensed image from the camera, determining a location of a laser spot with respect to the sensed image, and controlling an aspect of the display in response to the location of the spot.

In another aspect, the invention provides a method including: displaying an image on a monitor; producing an optical spot on a translucent material adjacent to the monitor; sensing the image and optical spot; and controlling an aspect of the image in response to the position of the optical spot.

### BRIEF DESCRIPTION OF THE DRAWINGS

The single drawing is a block diagram of a system constructed in accordance with an aspect of the invention.

### DETAILED DESCRIPTION OF THE INVENTION

In the information systems mentioned above, it would be desirable to issue commands to a computer system using remote control of a cursor or mouse pointer displayed on the monitors.

In one aspect, this invention uses a laser pointer (also referred to as a laser mouse) to allow interaction with one or more monitors, or computer displays, from a distance with no physical contact. The user directs a laser beam from a laser pointer onto the monitor screens at a desired location. One or more cameras can be used to detect images on the monitors. The cameras can communicate with a computer that is driving the monitors. Software running on the computer processes the images received from the cameras, and detects the presence of a bright dot from a laser pointer. Once the bright dot is detected, the dot's position relative to the image is calculated and the computer can move a cursor or mouse pointer on the display to that position.

To accomplish the position determination accurately, a calibration routine can be executed prior to use. A mouse ‘click’ can be generated when the user extinguishes the laser within an active area on the screen. Besides searching for the brightest point, the software can disregard areas of the screen with stationary illumination. This, along with an optical bandpass filter placed in front of the camera lens, helps reduce interference from ambient light.

Many computers are equipped to drive multiple monitors to extend the desktop. In one embodiment, the system can include multiple monitors. The system can be implemented using low cost, off-the-shelf USB Web cameras. If a laser pointer having a red beam is used, a red filter disk can be positioned in front of the camera lens to improve the camera's response to the red laser pointer.

The system can be implemented using a commercially available computer, signal processing software running on the computer, a Web camera, a red filter, a matte plastic sheet in front of the monitors, and an inexpensive 650 nm red laser pointer.

The drawing is a block diagram of a system 10 constructed in accordance with an aspect of the invention. The system includes first and second monitors 12, 14, each of which can be for example, a liquid crystal display (LCD), a cathode ray tube (CRT), or a plasma display (PD). A laser pointer 16 is used to project a small spot of light 18 onto the monitors.

Most monitors are equipped with anti-glare features. A laser pointed at a screen with anti-glare features will be redirected at roughly the angle of incidence (i.e., specular reflection of the laser beam). This could direct the reflected laser light out of the field of view of the camera and make the laser spot invisible to the camera at many angles. Screens which are glossy and reflective perform better, but reflected laser energy could be damaging to the eyes. By covering the monitor screen with a translucent material 20, 22, such as a thin layer of matte polyester, it is possible to achieve tracking performance that rivals a projection display without degrading the display image. The translucent material provides diffuse reflection of the laser beam, where the incident light is reflected in a broad range of directions.

In one embodiment, a 2 mil matte acetate can be used as the translucent material. In many cases, no adhesive is required; the translucent material can adhere to the monitor by static electricity. However, a low tack non-permanent adhesive may be used for long term installations.

Optical bandpass filters 24, 26 can be placed in front of the lens on each camera 28, 30, to reduce interference from ambient light. The filters can be chosen to transmit light at the wavelength emitted by the laser pointer, and to block a significant portion of light at other wavelengths.

Images sensed by the cameras are transmitted to the processor or computer 32, also referred to as a presentation machine, for processing. The computer captures video frames as shown in block 34. These frames are converted to grayscale as shown in block 36. Background information can be removed using background removal and thresholding software as shown in block 38. As shown in block 40, if the laser spot is not detected, another frame can be captured. If the laser spot is detected, the software can check to see if the computer is in a calibration mode as shown in block 42. If the calibration mode is enabled, a calibration procedure will be performed as shown in block 44, and the monitor calibration settings will be set as shown in block 46. Then the software can calculate the position of a cursor in response to the laser spot position and a click function can be sensed as shown in block 48.

The laser mouse can be implemented in a clinical environment, such as a hospital. In one implementation, two screens can be mounted in each patient room, one with patient information, the other with provider content. Each service provider can use his or her own pointer. The patient can also use a pointer. The ease of use of the laser mouse may promote a high degree of interaction between service providers, the patient, and the system. In another implementation, a single screen can be mounted in the patient room, and that screen can be used to display the necessary information. By eliminating the need for direct physical contact between service providers, the patient, and the system, the invention seeks to reduce the spread of infection, and reduce the costs compared to other patient remote control solutions.

Because no physical contact with the display is necessary as with touch screens, the laser mouse is ideal for use in patient rooms where infection control concerns exist. It is also an alternative to a remote mouse or trackball for presentations.

The apparatus shown in the drawing implements a method including the steps of displaying an image on a monitor; producing an optical spot on a translucent material adjacent to the monitor; sensing the image and optical spot; and controlling an aspect of the image in response to the position of the optical spot. The controlled aspect of the display can be, for example, the location of a cursor or mouse pointer in the display, or the activation of buttons or links contained in the display.

Using a low cost pointer, the presence, and then absence of the laser spot can be detected and interpreted as a mouse ‘click’. Thus mouse movement and click functions can be implemented. Other events could be simulated, for example using a ‘tool bar’ where the user grabs and drags a ‘double click’ icon to the place where a double click is desired.

It should be understood that the invention is not limited to the particular apparatus described in the drawing, but can include other components or devices that implement additional features.

While the invention has been described in terms of a preferred embodiment, it will be apparent to those skilled in the art that various changes can be made to the described embodiment without departing from the scope of the invention as defined in the following claims.

What is claimed is:

1. An apparatus comprising:
a monitor;
a camera for sensing an image on the monitor;
a translucent material positioned between the monitor and the camera; and
a processor for receiving the sensed image from the camera, determining a location of a laser spot with respect to the sensed image, and controlling an aspect of the display in response to the location of the spot.

2. The apparatus of claim 1, wherein the translucent material is positioned adjacent to the monitor.

3. The apparatus of claim 1, wherein the translucent material comprises one of:
a matte polyester film or a matte acetate film.

4. The apparatus of claim 1, further comprising:
an optical bandpass filter positioned between the monitor and the camera, wherein the optical filter transmits light at the frequency of the laser spot.

5. The apparatus of claim 1, wherein the monitor includes one of:
a liquid crystal display, a cathode ray tube, or a plasma display.

6. The apparatus of claim 1, further comprising:
a laser for producing a beam that strikes the monitor and produces the laser spot.

7. The apparatus of claim 6, wherein translucent material provides diffuse reflection of the laser beam.

8. A method comprising:
displaying an image on a monitor;
producing an optical spot on a translucent material adjacent to the monitor;
sensing the image and optical spot; and
controlling an aspect of the image in response to the position of the optical spot.

9. The method of claim 8, wherein the sensing step comprises:
capturing the image as a video frame;
converting the video frame to grayscale; and
removing background information from the video frame.

10. The method of claim 9, wherein the controlling step comprises:
determining the position of the optical spot in the video frame;
sensing a click function in response to the optical spot; and
updating the monitor in response to the click function.

11. The method of claim 10, wherein the click function is implemented by turning off the optical spot.

12. The method of claim 10, wherein the updating step comprises:
calculating the optical position relative to the image; and
moving a cursor on the display to the calculated position.

13. The method of claim 8, wherein the controlling step is performed by a processor, and the method further comprises:
determining if the processor is in a calibration mode; and
if the calibration mode is enabled, performing a calibration procedure to set calibration settings of the monitor.

14. The method of claim 8, wherein the removing step comprises:
using background removal and thresholding software.
